(19) United States
(12) Patent Application Publication
(10) Pub. No.: US 2015/0049035 A1
(43) Pub. Date: Feb. 19, 2015

(54) METHOD AND APPARATUS FOR PROCESSING INPUT OF ELECTRONIC DEVICE

(71) Applicant: Samsung Electronics Co., Ltd., Suwon-si (KR)

(72) Inventors: Jeongseob KIM, Daegu (KR); Yonggil HAN, Gumi-si (KR)

(21) Appl. No.: 14/458,672

(22) Filed: Aug. 13, 2014

(30) Foreign Application Priority Data
Aug. 19, 2013 (KR) 10-2013-0097875

(51) Int. Cl. G06F 3/041; G06F 3/01; G06F 3/042

(52) U.S. Cl. CPC G06F 3/0418; G06F 3/0425; G06F 3/013; G06F 2203/04106
USPC 345/173

(57) ABSTRACT

A method for processing an input of an electronic device is provided. The method includes displaying an object on a screen, detecting coordinates of a position at which a hovering occurs when a hovering input is detected, acquiring eye position information of a user by driving a camera, and processing the hovering by selecting and processing a hovering input matching with the eye position information.

### CROSS-REFERENCE TO RELATED APPLICATION(S)

This application claims the benefit under 35 U.S.C. §119(a) of a Korean patent application filed on Aug. 19, 2013 in the Korean Intellectual Property Office and assigned Serial number 10-2013-0097875, the entire disclosure of which is hereby incorporated by reference.

### TECHNICAL FIELD

The present disclosure relates to a method and an apparatus for processing a hovering input of an electronic device including a touch device.

### BACKGROUND

Currently, the use of various electronic devices capable of communication and the processing of personal information, for example, devices such as a mobile terminal, a smart phone, a tablet Personal Computer (PC), etc., are becoming more common, with the development of digital technology. The electronic device provides various functions such as a call function, a function for writing documents and e-mails, a media playback function, such as music and/or video playback function, an internet function, and a Social Networking Service (SNS) function.

In particular, the electronic device supports a function for collecting and storing an image on an object depending on the control of a user by being equipped with a camera. Further, with advances in technology, the electronic device supports a function by which the proximity object is recognized on a display depending on a detecting signal if a proximity object is detected by a non-contact method without touching a screen by using a touch panel of a proximity touch method for the user's convenience. The non-contact method may include a hovering of an input tool, a user's finger, an electronic pen, etc., and a position at which the largest signal is detected is determined as a recognition point when the hovering is detected at another position and a similar height of the touch panel by the input tool.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an electronic device including the touch device, a pointer detecting the hovering may occur at two or more positions depending on the position of the input tool. As a result, the position of the hovering may be misrecognized because the hovering pointer displayed in the touch device moves back and forth quickly among the two or more points. In this case, the electronic device including the touch device has a problem in that another position at which the user does not intend actually may be detected as the hovering pointer. That is, the electronic device cannot correctly detect the hovering input occurred by the user and/or an input which the user wants.

Another aspect of the present disclosure is to provide a method and an apparatus for improving the accuracy of the hovering input for operating an object displayed on a screen.

The electronic device of the present disclosure can acquire eye position information of a user through a camera when a hovering input is detected, and select the hovering input matching with the eye position information of the user. Therefore, the electronic device may accurately detect the hovering input of the position at which the user wants, and accurately select the object corresponding to the hovering input.

In accordance with an aspect of the present disclosure, a method for processing an input of an electronic device is provided. The method includes displaying an object on a screen, detecting coordinates of a position at which the hovering occurs when a hovering input is detected, acquiring eye position information of a user by driving a camera, and processing the hovering by selecting and processing the hovering input matching with the eye position information of the user.

In accordance with an aspect of the present disclosure, a method for processing an input of an electronic device is provided. The method includes displaying an object on a screen, acquiring eye position information of a user by driving a camera when a hovering input is detected, detecting coordinates of a position at which a hovering occurs, and selecting and processing the hovering input matching with the eye position information of the user.

In accordance with an aspect of the present disclosure, an apparatus for processing an input of an electronic device is provided. The apparatus includes a touch screen configured to display an object and detecting a hovering input in the object, a camera configured to acquire eye position information of a user, and a controller configured to control to display an object on the touch screen, to detect coordinates of a position at which a hovering occurs when a hovering input is detected in the object, to acquire eye position information of a user by driving the camera, and to control to select and process the hovering input matching with the eye position information of the user.

In accordance with an aspect of the present disclosure, an apparatus for processing an input of an electronic device is provided. The apparatus includes a touch screen configured to display an object and to detect a hovering input in the object, a camera configured to acquire eye position information of a user, and a controller configured to control to display an object on the touch screen, to acquire eye position information of a user by driving the camera when a hovering input is detected in the object, to detect coordinates of a position at which a hovering occurs, and to control to select and process the hovering input matching with the eye position information of the user.

The electronic device according to various embodiments of the present disclosure is effective in reducing the occurrence of malfunctions of the hovering by determining a position of a hovering pointer based on eye position information of a user.

Further, the present disclosure is effective in increasing the user's convenience of the electronic device by allowing to be more adaptively operated a function provided by the electronic device.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram illustrating a configuration of an electronic device according to an embodiment of the present disclosure.

FIG. 2 is a flow diagram illustrating a method for processing a hovering input based on eye position information of a user according to an embodiment of the present disclosure.

FIGS. 3A, 3B, 3C, and 3D are diagrams for explaining a first example of a method for processing a hovering input based on eye position information of a user according to an embodiment of the present disclosure.

FIGS. 4A, 4B, and 4C are diagrams for explaining a second example of a method for processing a hovering input based on eye position information of a user according to an embodiment of the present disclosure.

FIG. 5 is a flow diagram illustrating still another method for processing a hovering input based on eye position information of a user according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Prior to the detailed description, an electronic device according to an embodiment of the present disclosure may be a mobile communication terminal, a smart phone, a tablet Personal Computer (PC), a hand-held PC, a Portable Multimedia Player (PMP), a Personal Digital Assistant (PDA), a notebook PC or the like.

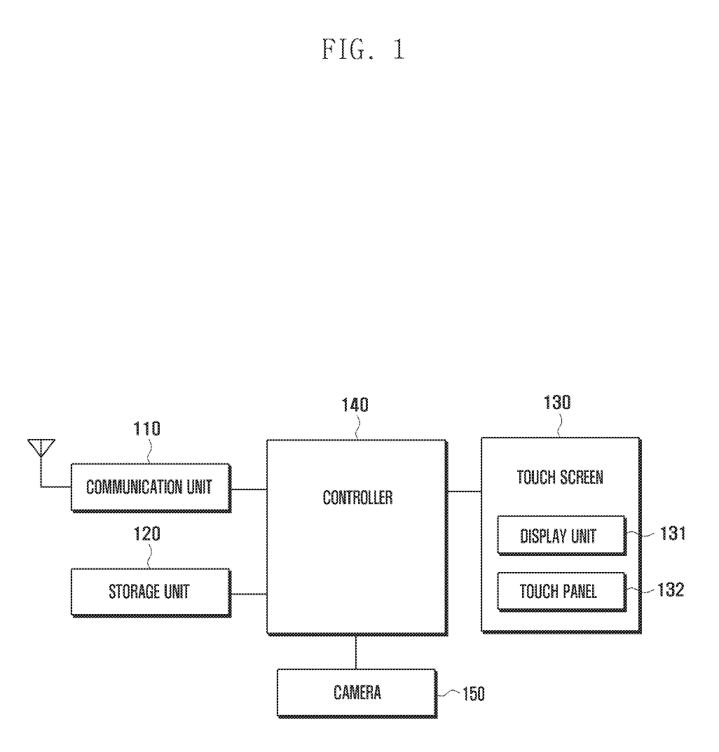

FIG. 1 is a block diagram illustrating a configuration of an electronic device according to an embodiment of the present disclosure.

Referring to FIG. 1, the electronic device of the present disclosure may include a communication unit 110, a storage unit 120, a touch screen 130, a controller 140, and a camera 150.

The electronic device of the present disclosure having such a configuration may collect an image by activating, automatically, the camera 150 if a specific user function, for example, a finger hovering and/or an electronic pen hovering, is activated.

The communication unit 110 performs voice communication, video communication, or data communication with an external device through a network. The communication unit 110 may be configured by a Radio Frequency (RF) transmitter, which up-converts and amplifies a frequency of a transmitted signal, and an RF receiver, which low-noise amplifies a received signal and down-converts a frequency of the received signal. Further, the communication unit 110 may include a modulator and a demodulator. The modulator and the demodulator may include and/or provide the following communication standards and/or systems, Code Division Multiple Access (CDMA), Wideband-CDMA (WCDMA), Long Term Evolution (LTE), Wireless-Fidelity (Wi-Fi), Wireless Broadband (WIBRO), Bluetooth, and Near Field Communications (NFC). The communication unit 110 may be a mobile module, an internet module and/or a short distance communication module.

The storage unit 120 may include a program memory for storing an operation program of the electronic device and a data memory for storing data generated while a program is performed.

The touch screen 130 may be configured integrally including a display unit 131 and a touch panel 132. The display unit 131 may display various screens according to the use of the electronic device under control of the controller 140. The display unit 131 may be configured by a Liquid Crystal Display (LCD), an Organic Light Emitted Diode (OLED), an Active Matrix OLED (AMOLED), or any other similar and/or suitable display type. The touch panel 132 may be a complex touch panel, including a hand touch panel for detecting a hand gesture, and a pen touch panel for detecting a pen gesture.

In particular, in an embodiment of the present disclosure, the display unit 131 may display one or more objects, for example, icons, thumbnails, list items, menu items, text items, link items, etc., under controlling of the controller 140. If a hovering input is detected by the touch panel 132 in the object displayed on the display unit 131, a signal of the hovering input may be transmitted to the controller 140. A hovering input may be a type of input that excludes physical contact between an input device performing the hovering input and a device receiving the hovering input, i.e., the touch screen 131 or any other similar and/or suitable device that may receive a hovering input. In further detail, a hovering input may be an input that is performed within a predetermined range of the touch screen 130, or any other similar and/or suitable display device and/or input receiving device, wherein the predetermined range excludes contact with the touch screen 130 or any other similar and/or suitable display device and/or input receiving device.

The controller 140 controls overall operation of the electronic device and signal flow between internal configurations of the electronic device, performs a function of processing data, and controls the power supply from a battery to the configurations.

In particular, in an embodiment of the present disclosure, the controller 140 may control the display unit 131 to display one or more objects, for example, icons, thumbnails, list items, menu items, text items, link items, etc. In the object displayed on the display unit 131, the controller 140 may detect a hovering input through the touch panel 132. If a hovering occurs, the controller 140 may detect coordinates of a position at which the hovering occurs. If the coordinates of the position at which the hovering occurs are detected, the controller 140 may acquire eye position information of a user by driving the camera 150. Here, the controller 140 may detect an area matching with the eye position information of the user, from among areas obtained by dividing the display unit 131 into a plurality of eye tracking areas. Further, the controller 140 may compare the eye position information of the user with the coordinates detected by the hovering and determine the matching coordinates as hovering pointer coordinates if the eye position information of the user matches with the coordinates detected by the hovering. Further, the controller 140 may process the object corresponding to the determined hovering pointer coordinates.

The camera 150 performs a function of shooting an object, or in other words, capturing an image of an object, and outputting the result to the controller 140. Specifically, the camera 150 may include a lens for collecting light, an image sensor for converting the collected light into an electrical signal, and an image signal processor for processing the electrical signal, which is input from the image sensor, into raw data and outputting the processed electrical signal to the controller 140.

In particular, in an embodiment of the present disclosure, in a case where a hovering is detected, the camera 150 may acquire eye position information of a user by being activated under controlling of the controller 140. Further, the controller 140 may collect an image through the camera 150. Specifically, if the image is collected through the camera 150, a face of a certain form is recognized based on facial recognition. And then, a region of eyes may be extracted from the recognized face and information on an eye angle of pupils may be collected from the region of eyes. A position of a user's eyes may be determined by using the collected eye angle of pupils. Various methods, such as a method of using information of the light of an eyeball emitting distinct light from a face, a method of recognizing an eyeball by detecting an iris of an eye, and a method of using information on the color of an eye in contrast with the color of a face, may be used as a method of recognizing the pupil of an object. Here, the image collected through the camera 150 may be any one of a still image collected at constant time intervals—that is, periodically—and a real time image. The camera 150, if a signal of a hovering input is not detected, may be automatically terminated under controlling of the controller 140.

In addition, the electronic device may further include components having additional functions, such as a Global Positioning System (GPS) module for receiving position information, an audio processor including a mic and a speaker, and an input unit for supporting a hard key based input, but the description and illustration of the components are omitted and/or not shown in FIG. 1.

In general, an eye tracking is a technology of tracking an eye position by detecting the movement of a pupil, and it may be implemented in various methods, for example, a video analysis method, a contact lens method, a sensor attachment method, etc. In an embodiment of the present disclosure, it is assumed that the video analysis method is used. In this case, the controller 140 includes an eye tracker, and the eye tracker may detect the movement, such as the rotation, of the pupil by analyzing an image output from the camera, and calculate a fixed position reflected on a cornea using an eye direction. At this time, the movement of a head may be referenced. This is in accordance with a property in which the eye direction coincides with the movement of the head, generally.

Further, in an embodiment of the present disclosure, the display unit 131, and/or the touch panel 132, is divided into areas each having a certain size, and each of the divided areas is configured as an eye tracking area. This is for determining a position matching with user's eye. That is, if user gazes at an object displayed on the display unit 131 while using the electronic device, the user's eye also is directed to the object displayed on the display unit 131. Therefore, a plurality of eye tracking areas are allocated in the display unit 131 and then, if a hovering is detected, the controller 140 detects the eye tracking area matching with the user's eye through the eye tracker and determines a hovering input detected in the eye tracking area to which the eye is directed is determined as an input which the user wants.

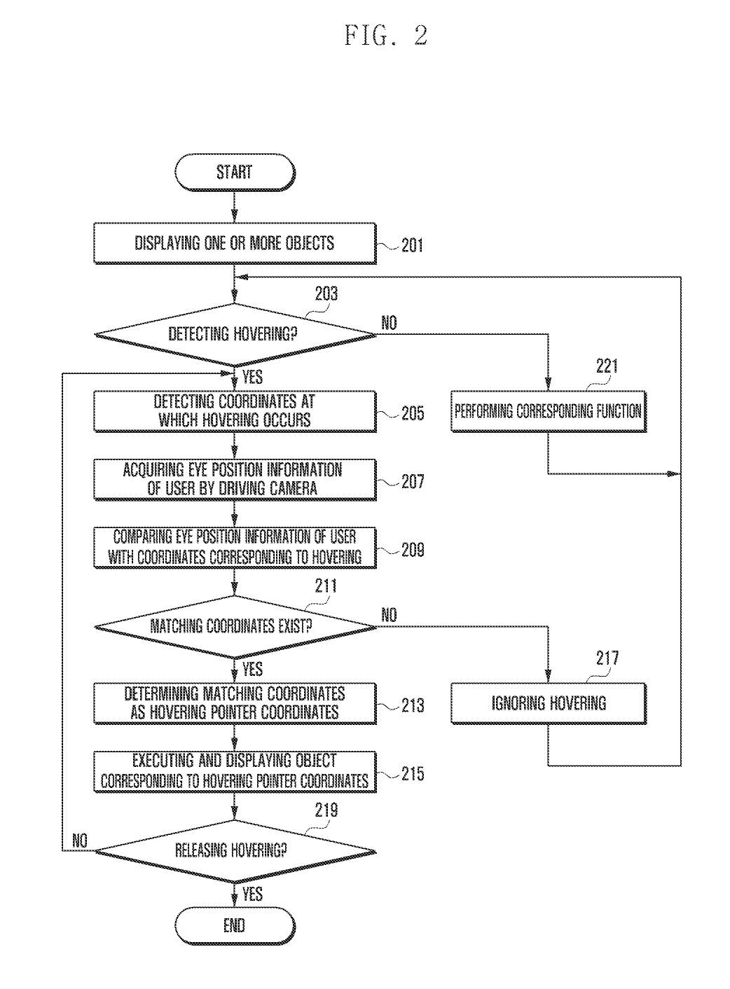

FIG. 2 is a flow diagram illustrating a method for processing a hovering input based on eye position information of a user according to an embodiment of the present disclosure.

Referring to FIG. 2, the controller 140, according to an embodiment of the present disclosure, in operation 201, may control the display unit 131 to display one or more objects. Here, the object may include components configuring a screen of the display unit 131, for example, icons, thumbnails, list items, menu items, text items, and link items. While the object is displayed on the display unit 131, the controller 140, in operation 203, may determine whether the hovering input is detected, through the touch panel 132. The hovering may be detected if an input tool, for example, a user's finger, an electronic pen, etc., is close to the touch screen 130, for example, if an input tool enters into a distance of a certain height, i.e., if the input tool is within a certain range and/or distance, from the surface of the touch screen 130. In an embodiment of the present disclosure, the input tool is explained by assuming that it is a user's finger, but it is not limited thereto, and it may be an electronic pen, or any other similar and/or input tool may be used. If a hovering does not occur, the controller 140, in operation 221, may perform a corresponding function, such as a touch gesture detection.

On the other hand, if a hovering occurs, the controller 140 may detect this, in operation 203, and detect coordinates of a position at which the hovering occurs, i.e., coordinates corresponding to and/or detected according to the hovering, in operation 205. Here, at least one set of coordinates may be detected. If coordinates are detected by the controller 140, the controller 140 may acquire eye position information of a user by driving the camera 150, in operation 207. In this case, the controller 140 may acquire eye information by collecting a face image, including pupils, through the camera 150. Here, a step for acquiring eye position information of the user is an operation for determining whether the coordinates detected by the hovering are coordinates of the position actually intended by the user. Specifically, an area matching with user's eye, from among areas obtained by dividing the display unit 131 into a plurality of eye tracking areas, may be determined as eye position information of the user.

Subsequently, the controller 140, in operation 209, may compare the coordinates detected according to the hovering with the eye position information of the user, and, in operation 211, may determine whether the coordinates detected according to the hovering match with the eye position information of the user in order to determine if matching coordinates exist. In this case, if there is at least one set of matching coordinates, the controller 140 may detect the matching coordinates, in operation 211, and may determine the matching coordinates as hovering pointer coordinates, in operation 213.

Specifically, if there are a plurality of coordinates detected according to the hovering, the controller 140 may determine matching coordinates, from among a plurality of coordinates, as hovering pointer coordinates, and coordinates which do not match, from among the plurality of coordinates, may be ignored. Further, if a plurality of coordinates do not match with the eye position information of the user, the controller 140 may determine to ignore the plurality of coordinates. Further, if there are coordinates detected according to the hovering, the controller 140 may determine whether the detected coordinates match with the eye position information of the user. And then, the controller 140 may determine the matching coordinates as hovering pointer coordinates if the detected coordinates match with the eye position information of the user, and may determine to ignore the detected coordinates if the detected coordinates do not match with the eye position information of the user.

Next, the controller 140, in operation 215, may execute the object corresponding to the hovering pointer coordinates and control the display unit 131 to display the executed object.

On the other hand, if there are not coordinates matching with the eye position information of the user, from among the coordinates detected according to the hovering, in the operation 211, the controller 140 does not display the hovering pointer coordinates by determining that the hovering does not occur, and accordingly, the controller 140 ignores the hovering, in operation 217. That is, the controller 140 does not execute the object corresponding to the coordinates of a position at which the hovering occurs.

After performing operation 215, the controller 140 may determine whether the hovering is released in operation 219. If a signal of the hovering input is not received from the touch panel 132, the controller 140 may determine that the hovering is released. If the hovering is released, the controller 140 may terminate the function of the hovering and the driving of the camera 150. On the other hand, if the hovering is not released, the controller 140 may detect the coordinates of the position at which the hovering occurs, by branching to operation 205.

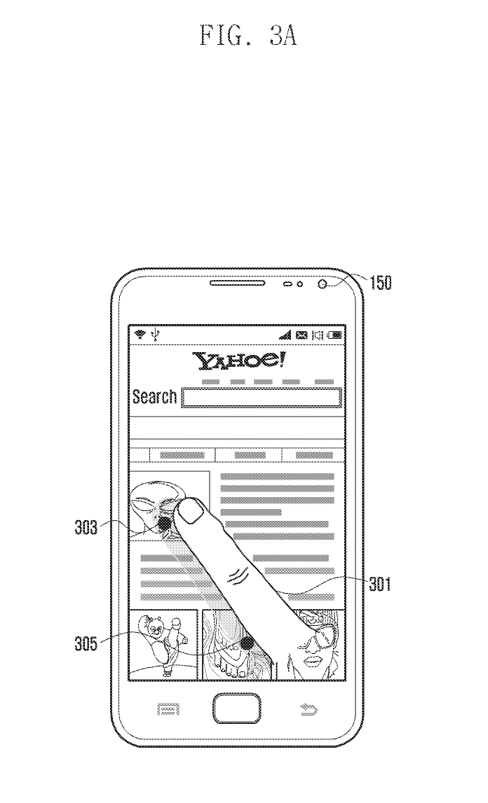

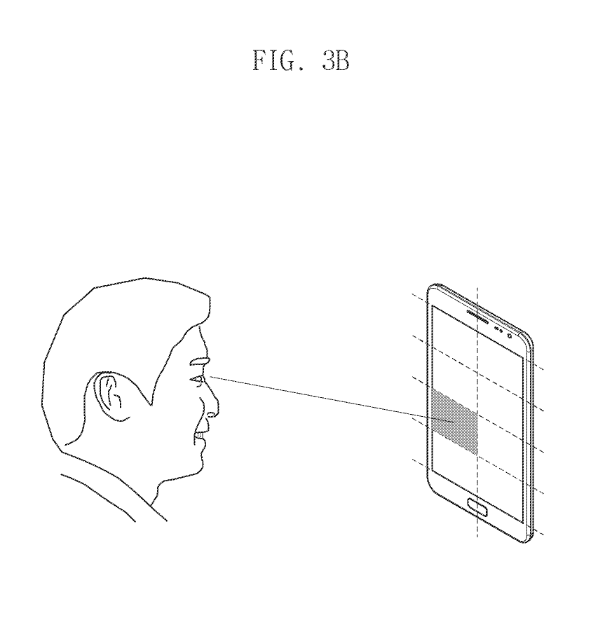

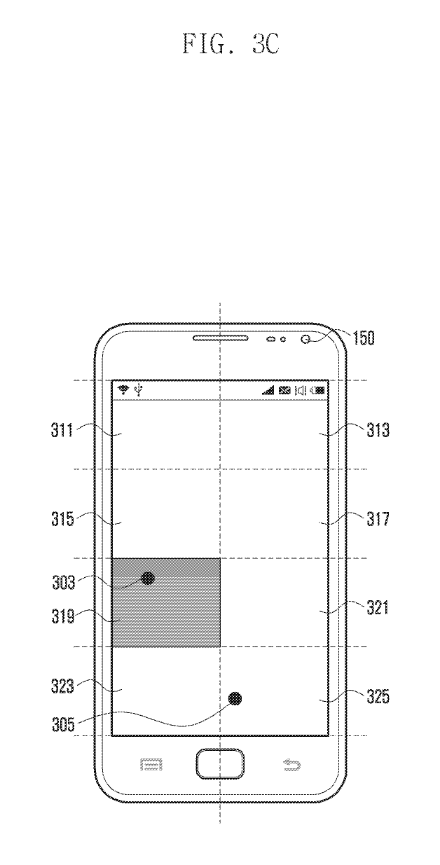

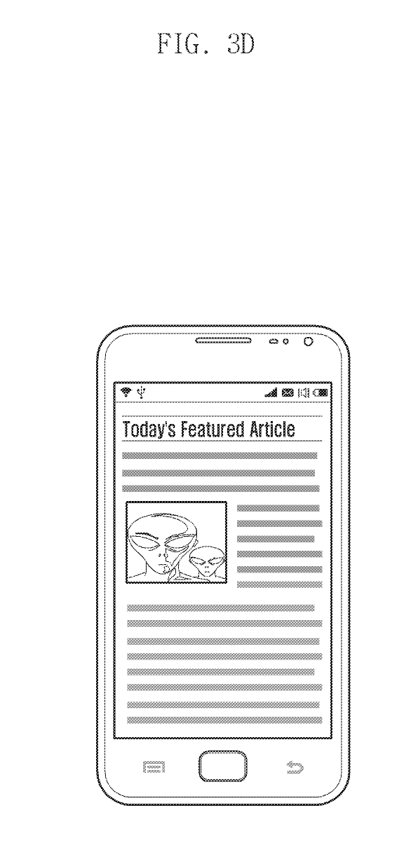

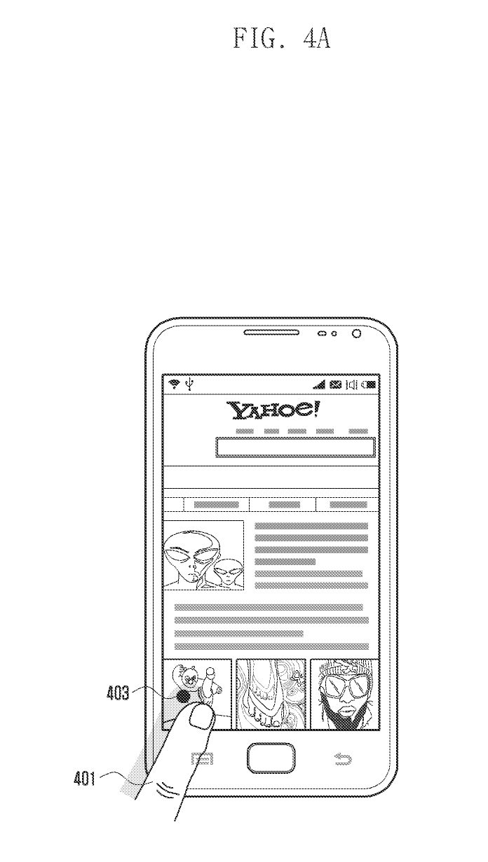

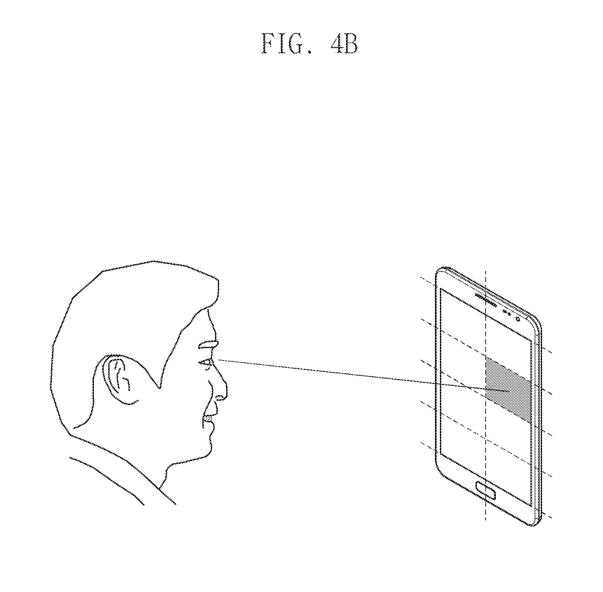

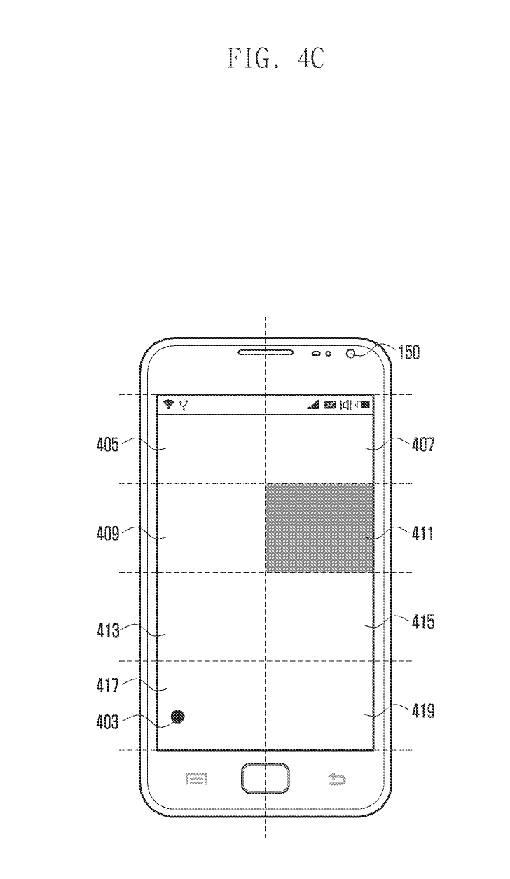

Hereafter, referring to the diagrams of FIGS. 3A to 4C, a method for processing a hovering input will be specifically described based on eye position information of a user. According to an embodiment of the present disclosure, the hovering input will be described by assuming that it occurs by a user's finger, but it is not limited thereto, and the hovering may be detected through the electronic pen, etc.

FIGS. 3A to 3D are diagrams for explaining a first example of a method for processing a hovering input based on eye position information of a user according to an embodiment of the present disclosure.

According to an embodiment of the present disclosure, a method for processing a hovering input when a plurality of coordinates are detected by a hovering input will be described through the diagrams of the FIGS. 3A to 3D.

Referring to FIGS. 3A to 3D, the controller 140 may control the display unit 131 to display a web page screen as shown in FIG. 3A. In the web page screen, the controller 140 may detect a finger hovering 301 through the touch panel 132. Here, if a finger is positioned on the touch screen 130, a plurality of hovering coordinates may be recognized according to the fingers or the skin around the finger having the intention of actual operation. Thus, a plurality of hovering coordinates 303 and 305 may detected according to the finger hovering 301 of FIG. 3A.

Further, for example, in the case in which a plurality of hovering coordinates are recognized, if two fingers are placed on the touch screen 130, a plurality of hovering coordinates may be detected due to the placement of the two fingers. Further, if a finger is laid down on the touch screen 130, so that a first knuckle and a second knuckle of the finger are recognized as they are at a similar position, a plurality of hovering coordinates may be detected.

If the plurality of hovering coordinates 303 and 305 are detected, the controller 140 may acquire the eye position information of the user by driving the camera 150 as shown in FIG. 3B. In this case, the controller 140 may identify the eye position information of the user by dividing the display unit 131 into eight eye tracking areas 311, 313, 315, 317, 319, 321, 323, and 325, as shown in FIG. 3C.

Specifically, an area matching with user's eye on the display unit 131, which is divided into the plurality of eye tracking areas 311, 313, 315, 317, 319, 321, 323, and 325, may be determined as eye position information of a user. According to an embodiment of the present disclosure, the dividing of the display unit 131 into a plurality of eye tracking areas is for determining eye position information, but not limited thereto, and the eye position information of the user may be identified by other methods while implementing in practice. It may be determined that the hovering coordinates 303 and 305, which are coordinates detected according to the finger hovering, are positioned in eye tracking areas 319 and 325 area of FIG. 3A, respectively. Here, two hovering coordinates which are detected, (that is, hovering coordinates 303 and 305, may be hovering pointer coordinates or may be not hovering pointer coordinates depending on the hovering coordinates 303 and 305 match the eye position information of the user. In this case, if it is detected that the user's gaze acquired by driving the camera 150 is directed to eye tracking area 319, the controller 140 may determine the hovering coordinates 303 positioned in eye tracking area 319 as hovering pointer coordinates. Further, the controller 140 may execute the object corresponding to the hovering coordinates 303 and display an execution screen as shown in FIG. 3D.

FIGS. 4A to 4C are diagrams for explaining a second example of a method for processing a hovering input based on eye position information of a user according to an embodiment of the present disclosure.

According to an embodiment of the present disclosure, a method for processing the hovering input, when a set of coordinates is detected by a hovering input, will be described through the diagrams of FIGS. 4A to 4C.

Referring to FIGS. 4A to 4C, the controller 140 may control the display unit 131 to display a web page screen as shown in FIG. 4A. In the web page screen, the controller 140 may detect a finger hovering 401 through the touch panel 132. In this case, coordinates 403 of the hovering may be detected. To determine whether the coordinates 403 are coordinates of a hovering pointer position intended by the user, the controller 140 may identify eye position information of a user by driving the camera 150 as shown in FIG. 4B. In this case, the controller 140 may identify the eye position information of the user by dividing the display unit 131 into eight eye tracking areas 405, 407, 409, 411, 413, 415, 417, and 419, as shown FIG. 4C. According to an embodiment of the present disclosure, the dividing the display unit 131 into a plurality of eye tracking areas is for determining the eye position information of the user, but it is not limited thereto, and the eye position information of the user may be identified by another method when an embodiment of the present disclosure is implemented in practice.

Coordinates 403, which are coordinates detected according to the finger hovering, may be positioned in the eye tracking area 417 of FIG. 4C. In this case, if it is detected that user's eye acquired by driving the camera 150 is directed to the eye tracking area 411 of FIG. 4C, the controller 140 may determine that the coordinates 403, which are coordinates detected according to the finger hovering, are coordinates of which a hovering is ignored. That is, the object of that position is not executed because a hovering is ignored. Thus, the detected hovering may be ignored if the position at which a hovering is detected is different from the eye position information of the user acquired by driving the camera 150.

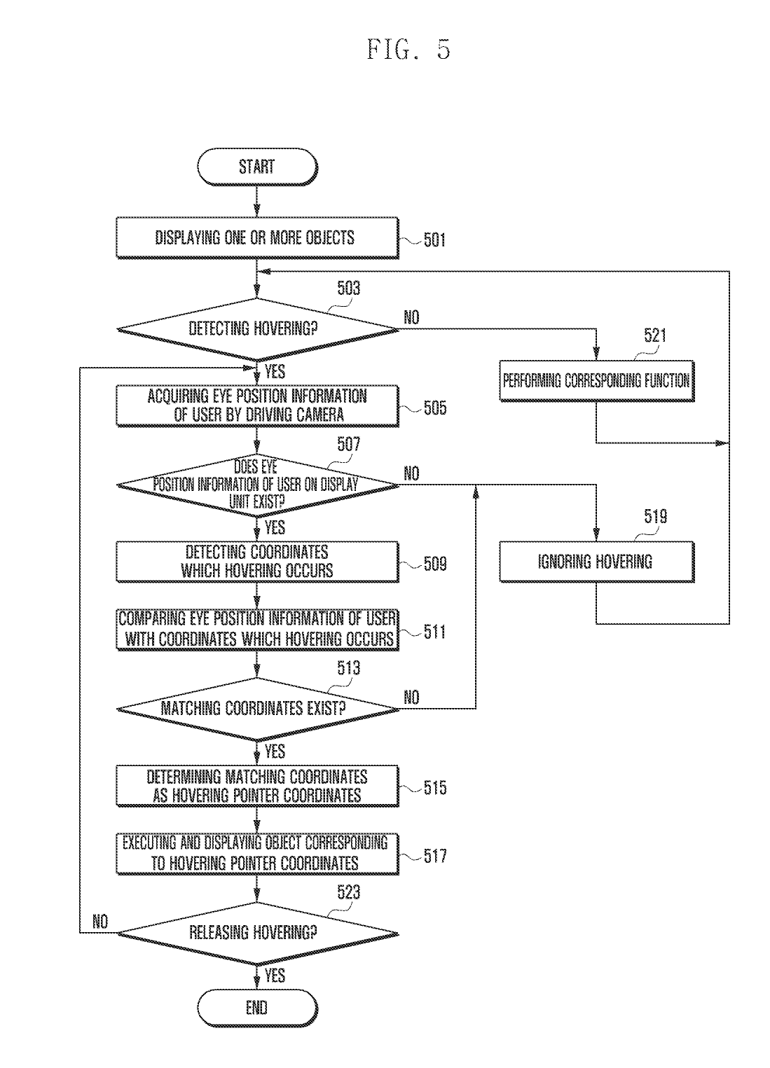

FIG. 5 is a flow diagram illustrating still another method for processing a hovering input based on eye position information of a user according to an embodiment of the present disclosure.

Referring to FIG. 5, the controller 140, in operation 501, may control the display unit 131 to display one or more objects. Here, the object may include components configuring the screen of the display unit 131, for example, icons, thumbnails, list items, menu items, text items, and link items, In the object displayed on the display unit 131, the controller 140 may determine whether a hovering input is detected, through the touch panel 132, in operation 503. The hovering may be detected when an input tool, for example, a user's finger, an electronic pen, etc., is close to the touch screen 130, for example, if an input tool enters into and/or is within a distance of the certain height from the surface of the touch screen 130. If a hovering does not occur, the controller 140 may perform the corresponding function, such as a touch gesture detection, in operation 521.

On the other hand, if a hovering occurs, the controller 140 may acquire the eye position information of the user by driving the camera 150, in operation 505. Here, the process for acquiring the eye position information of the user is an operation for determining whether coordinates detected according to the hovering are coordinates of a position actually intended by the user. Specifically, an area matching with the user's eye, from among areas obtained by dividing the display unit 131 into a plurality of eye tracking areas, may be determined as the eye position information of the user.

In this case, the controller 140 may determine whether the user's gaze, as acquired by driving the camera 150, is directed to the display unit 131. If eye position information of the user is directed to the display unit 131, the controller 140 may determine whether eye position information of the user on the display unit 131 exists, in operation 507, and then detect coordinates of a position at which the hovering occurs, in operation 509. Subsequently, the controller 140 may determine whether the coordinates detected by the hovering match with the eye position information of the user by comparing the coordinates detected by the hovering with the eye position information of the user in operation 511.

The controller 140 may determine, in operation 513, if the coordinates detected by the hovering match with the eye position information of the user, or in other words, if matching coordinates exist, and then may determine the coordinates as hovering pointer coordinates, in operation 515. Subsequently, the controller 140 may execute and display the object corresponding to the hovering pointer coordinates, in operation 517.

On the other hand, if the coordinates detected by the hovering do not match with the eye position information of the user, in the operation 513, then the controller 140 does not display the hovering pointer coordinates by determining that the hovering does not occur, and ignores the hovering in operation 519. That is, the controller 140 does not execute the object of the coordinates detected by the hovering.

Subsequently, after performing operation 517, the controller 140 may determine whether the hovering is released, in operation 523. The controller 140, if the coordinates of the hovering are not received from the touch panel 132, may determine that the hovering is released. If the hovering is released, the controller 140 may terminate the function of the hovering and the driving of the camera 150. On the other hand, if the hovering is not released, the controller 140 may detect coordinates of a position at which the hovering occurs, by branching to operation 505.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method for processing an input of an electronic device, the method comprising:
displaying an object on a screen;
detecting coordinates of a position at which a hovering occurs when a hovering input is detected;
acquiring eye position information of a user by driving a camera; and
processing the hovering by selecting and processing a hovering input matching with the eye position information.

2. The method of claim 1, wherein at least one set of coordinates is detected.

3. The method of claim 1, wherein the acquiring of eye position information comprises:
acquiring an image of a user by driving a camera;
acquiring eye position information by detecting an eye direction in the acquired image; and
detecting an eye tracking area of a display unit to which a user's gaze is directed,
wherein the display unit is divided into a plurality of eye tracking areas to determine eye position information.

4. The method of claim 3, wherein the processing of the hovering comprises selecting and processing the hovering input of the coordinates in the eye tracking area of the display unit in which the eye position information is detected.

5. The method of claim 4, wherein the processing of the hovering comprises:
determining the coordinates of the position at which the hovering occurs as hovering pointer coordinates if the coordinates match with the eye position information; and
ignoring the coordinates of the position at which the hovering occurs if the coordinates do not match with the eye position information.

6. The method of claim 1, wherein the hovering input may be a user input that is performed within a predetermined range of the electronic device, the predetermined range excluding contact with the electronic device.

7. A method for processing an input of an electronic device, the method comprising:
displaying an object on a screen;
acquiring eye position information of a user by driving a camera when a hovering input is detected;
detecting coordinates of a position at which a hovering occurs; and
selecting and processing a hovering input matching with the eye position information.

8. The method of claim 7, wherein the acquiring of eye position information comprises ignoring coordinates detected by the hovering input if eye position information of the user, as acquired by driving the camera, is not detected in an eye tracking area of a display unit.

9. The method of claim 7, wherein the hovering input may be a user input that is performed within a predetermined range of the electronic device, the predetermined range excluding contact with the electronic device.

10. An apparatus for processing an input of an electronic device, the apparatus comprising:
a touch screen configured to display an object and to detect a hovering input in the object;
a camera configured to acquire eye position information of a user; and
a controller configured to control to display an object on the touch screen, to detect coordinates of a position at which a hovering occurs when a hovering input is detected in the object, to acquire eye position information of a user by driving the camera, and to control to select and process a hovering input matching with the eye position information of the user.

11. The apparatus of claim 10, wherein the controller is further configured to control to acquire eye position information by acquiring an image of a user by driving the camera, to detect an eye direction in the acquired image, and to detect an eye tracking area of a display unit to which the gaze is directed.

12. The apparatus of claim 11, wherein the controller is further configured to control to select and process a hovering input of coordinates detected in the eye tracking area of the display unit in which the eye position information is detected.

13. The apparatus of claim 12, wherein the controller is further configured to controls to determine coordinates detected by the hovering input as hovering pointer coordinates if the coordinates match with the eye position information and to ignore the coordinates detected by the hovering input if the coordinates do not match with the eye position information.

14. The apparatus of claim 10, wherein the controller is further configured to determine the hovering input to be a user input that is performed within a predetermined range of the electronic device, the predetermined range excluding contact with the electronic device.

15. An apparatus for processing an input of an electronic device, the apparatus comprising:
a touch screen configured to display an object and to detect a hovering input in the object;
a camera configured to acquire eye position information of a user; and
a controller configured to control to display an object on the touch screen, to acquire eye position information of a user by driving the camera when a hovering input is detected in the object, to detect coordinates of a position at which a hovering occurs, and to control to select and process a hovering input matching with the eye position information of the user.

16. The apparatus of claim 15, wherein the controller, if the eye position information of the user acquired by driving a camera is not detected in an eye tracking area of a display unit, is configured to control to ignore coordinates detected by the hovering input.

17. The apparatus of claim 15, wherein the controller is further configured to determine the hovering input to be a user input that is performed within a predetermined range of the electronic device, the predetermined range excluding contact with the electronic device.
